(19) United States
(12) Patent Application Publication
(10) Pub. No.: US 2024/0345545 A1
(43) Pub. Date: Oct. 17, 2024

(54) Method and System for Autotuning a PID Controller on Electromechanical Actuators using Machine Learning

(71) Applicant: Vitesco Technologies USA, LLC, Auburn Hills, MI (US)

(72) Inventors: Sandeep Saini, Wauconda, IL (US); Jorge Alberto Hernandez-Estolano, Jalisco (MX); Sameer Nayak, Palatine, IL (US)

(73) Assignee: Vitesco Technologies USA, LLC, Auburn Hills, MI (US)

(21) Appl. No.: 18/750,654

(22) Filed: Jun. 21, 2024

Related U.S. Application Data
(63) Continuation of application No. PCT/US2022/082096, filed on Dec. 22, 2022.

(30) Foreign Application Priority Data
Dec. 23, 2021 (US) 63293163

(51) Int. Cl. G05B 11/42; G05B 13/02

(52) U.S. Cl. CPC G05B 11/42; G05B 13/027

(57) ABSTRACT

A system and method for determining gains of a Proportional-Integral-Derivative (PID) controller is disclosed. The method includes receiving actuator data from an actuator and determining a load torque of the actuator based on the received actuator data and a data model stored on memory hardware. The method also includes determining a gain based on the load torque and the actuator data and applying the gain to the actuator.

### TECHNICAL FIELD

The disclosure relates to a system and method for autotuning a PID controller controlling an electromechanical actuator using machine learning.

### BACKGROUND

Proportional-Integral-Derivative (PID) control is universally used as a control algorithm for a variety of applications due to their wide range of operating conditions and their straightforward operation. A PID controller is based on feedback. An output of a device or process is measured and compared with a target set point. When a difference is detected, a correction is calculated and applied to the device or process. The output of the device or process is measured again, and any required correction is recalculated. The PID controller is used to determine a desired actuator output by computing proportional, integral, and derivative responses and adding those three components to calculate the output, based on the sensor feedback. Tuning a PID controller includes complex mathematics to achieve an optimal performance in selecting process-specific values for a range on interacting parameters. As such, the process of finding these values is known as tuning. When the PID controller is optimally tuned, the device minimizes deviation from a set point and responds to disturbances or set point changes quickly with minimal overshoot.

Several methods for tuning the PID controller are available. One known method for tuning a PID controller describes calculating new PID controller parameters either directly through a formula associated with the Ziegler-Nichols reaction curve method or through an intermediate step of calculating an ultimate period and frequency from the time constant and dead time which are calculated from the period and amplitude of oscillation generated by a relay. Another method for tuning a PID controller determines gains of a PID controller utilizing a genetic algorithm. Yet another known method for autotuning parameters of a PID controller, includes computing parameters of a transfer function through two steps and determining precise parameters of the PID controller from the computed parameters of the transfer function. Another known PID control device identifies the rise characteristics of a controlled system by a step response method on changing a reference, then the device moves to PID control when an idle time and a slope successively obtained on the rise reach a predetermined value, and computes PID control parameters based on the idle time and slope obtained up to that point.

Another known method for tuning PID controllers, describes increasing a proportional control gain until a desired oscillation is obtained, then measuring an amplitude and period from the oscillation, followed by calculating an ultimate gain and an ultimate period based on the amplitude and period, and setting the parameters of the PID controller depending on the ultimate gain and period. Another known method for acquiring parameters in the process control includes determining a controlled variable output which is sampled to obtain a dead time and a maximum gradient, then the initial values of PID control parameters are calculated based on the dead time and the maximum gradient. In an adaptation section, a pulse transfer function of the process is acquired, and PID control parameters are calculated from an acquired pulse transfer function by using a partial matching method in a frequency region. Another method for tuning the PID controller includes determining the PID parameters for the PID controllers by monitoring a limit cycle generated in a controlled process to obtain characteristics of the process and determining optimum PID parameters to be used for succeeding process control based on the results of the limit cycle monitoring. Yet another known apparatus for tuning the PID controller includes a nonlinear controller connected in parallel with a PID controller, a circuit for identifying a dynamic characteristic of a process and a circuit for determining gains of the PID controller according to the dynamic characteristic.

Although there are several methods to tune a PID controller, there is still a need to eliminate manual tuning of the PID controller for an unseen load by autotuning PID gains to improve the performance of the electromechanical actuator systems.

### SUMMARY

One aspect of the disclosure provides a method for determining gains of a Proportional-Integral-Derivative (PID) controller. The method includes receiving, at data processing hardware, actuator data from an actuator in communication with the data processing hardware. The method includes determining, at the data processing hardware, a load torque of the actuator based on the received actuator data and a data model, the data model stored on memory hardware in communication with the data processing hardware. The method also includes determining, at the data processing hardware, a gain based on the load torque and the actuator data.

Implementations of the disclosure may include one or more of the following optional features. In some implementations, the load torque is forward fed to a current control of the PID controller. The method may further include receiving a duty cycle from the PID controller. The PID controller being in communication with the data processing hardware. The load torque is also determined based on the duty cycle.

In some examples, the data model includes neural network weights and biases along with other neural network parameters. Additionally, the actuator data may include a speed value and a current value associated with an electric motor of the actuator.

In some implementations, the data processing hardware includes a neural network. The data model may be generated based on training actuator data of one or more actuators run at different times under different parameters.

In some examples, the method also includes transmitting the gain to the PID controller, where the PID controller is configured to apply a correction to the actuator based on the gain.

Another aspect of the disclosure provides a system for computing Proportional-Integral-Derivative (PID) gains for improving performance of an electromechanical actuator. The system includes data processing hardware and memory hardware in communication with the data processing hardware. The memory hardware stores instructions that when executed on the data processing hardware cause the data processing hardware to perform operations that include the described method of the first aspect of the disclosure. The instructions associated with an autotuning system that includes a neural network and a gain estimator, and a PID controller.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 shows a schematic view of an exemplary architecture of a PID control system in communication with an actuator.

FIG. 2 shows a schematic view of an exemplary arrangement of operations for neural network implementations.

FIG. 3 shows a schematic view of an exemplary arrangement of operations for the estimation of parameters using RLSQ method.

FIG. 4 is a schematic view of an exemplary arrangement of operations for a method of determining gains of a Proportional-Integral-Derivative (PID) controller using the system of FIGS. 1-3.

Like reference symbols in the various drawings indicate like elements.

### DETAILED DESCRIPTION

A PID controller is a control loop mechanism using feedback that is widely used in a multitude of applications, such as but not limited to, industrial control systems and any applications that require continuously modulated control. For example, a PID controller may be used to regulate flow, temperature, pressure, levels, and many other industrial process variables. PID controllers continuously calculate an error value based on a difference between a desired value (i.e., a setpoint) and a measured value (i.e., process variable). Based on the calculated error value, the PID controller applies a correction to a control function of an actuator.

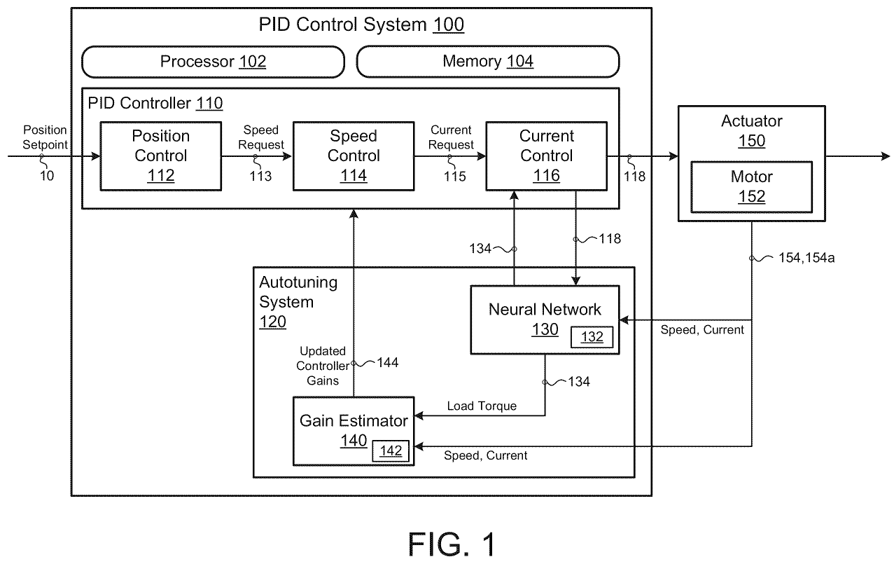

Referring to FIG. 1, the disclosure provides a PID control system 100 having a PID controller 110 and an autotuning system 120. The PID control system 100 includes a computing device or processor (e.g., data processing hardware) 102 (e.g., central processing unit having one or more computing processors) in communication with non-transitory memory 104 (e.g., a hard disk, flash memory, random-access memory, memory hardware) capable of storing instructions executable on the computing processor(s)). In some examples, the memory 104 is part of the processor 102. As will be described, the PID controller 110 and the and the autotuning system 120 are executed on the processor 102.

The PID control system 100 is in communication with an actuator 150 (e.g., electromechanical or hydraulic actuator) and applies a correction 118 to a control function of the actuator 150 to maintain a functionality of the actuator 150 within a predefined range or at a desired value. In some examples, the electromechanical actuator 150 is a mechanical actuator having a control knob or handle that has been replaced by an electric motor 152. The electromechanical actuator 150 may be used in a multitude of applications, including, but not limited to, automotive, aviation, medical Industrial (process control applications), consumer electronics The electromechanical actuator 150 shown in FIG. 1 is an Electronic Transmission Range Selection (ETRS) system. An ETRS system is an electronic transmission shifter that includes an actuator arm for shifting the transmission range from a Park position to an Out-of-Park position, such as, Reverse, Drive, Neutral etc. In some examples, the motor 152 may be a Brushless DC (BLDC) motor.

Since the performance of any actuator is greatly depended on how the control strategy is designed and calibrated, calibrating the actuator performance may be a time-consuming activity if the system dynamics are unknown. Additionally, the same control software used for tuning the PID controller 110 may need to be re-tuned for a different application when the load requirements change.

The PID control system 100 eliminates the need to manually tune the PID controller 110 due to the autotuning system 120 that determines PID gains 144 based on a load torque 134 determined by a neural network 130 of the autotuning system 120. The use of the neural network 130 makes it possible for the autotuning system 120 to be used in any application without manual tuning when a load of the actuator motor 152 is adjusted. In other words, the PID control system 100 significantly improves the performance of the electromechanical actuator 150 by autotuning PID gains independently of the type of the actuator 150.

Additionally, the PID control system 100 is independent of the application of the actuator 150 and provides fast, stable, and efficient response. The selected algorithm 142 of the gain estimator 140 computes the PID gains 144 in real time while running in low priority interrupt in the background. In some examples, multiple interrupts are running on the processor to perform various tasks. The algorithm 142 of the gain estimator 140 is assigned the lowest priority to avoid burdening the processor to perform other higher priority tasks. These gains 144 are then stored in memory 104 (e.g., NVRAM). In some examples, the gains 144 are fetched by the PID controller 110 when the performance of the actuator drifts by a predefined threshold or on every ‘n’ number of cycles. The PID controller 110 may be a 3-stage nested PID controller 110, where the outermost loop is position based control 112 followed by speed control loop 114 and current control loop 116 respectively. The PID controller 110 is a closed loop control system that provides continuous control modulation

The PID controller 110 includes a position control 112, a speed control, and a current control 116. The position control 112 controls the position of the actuator 150 based on the position setpoint 10, the speed control 114 controls the speed of the actuator motor 152 based on the position setpoint 10, and the current control 116 controls an electric current to the motor 152 (i.e., electric motor) of the actuator 150. The PID controller 110 applies the correction 118 to the control function of the actuator 150 to maintain a functionality of the actuator 150 within a predefined range or at a specific value with respect to the actuator's position, speed, and/or current. The PID controller 110 includes an outermost position loop, followed by a speed and an innermost current loop. When a new range selection request is received by the actuator 150, the PID controller 110 commands a corresponding position on the actuator 150. The outermost position loop calculates the speed required for the inner speed loop to complete this shift using a proportional gain k_{p,p}. Similarly, the speed loop calculates the current required for the innermost current loop to overcome any disturbances or load on the motor to attain the requested speed and complete the shift. The speed loop uses proportional and integral gains, k_{p,s} and k_{i,s} respectively. The performance of the actuator 150 largely depends on the values of the gains mentioned above.

The autotuning system 120 includes a neural network 130 and a gain estimator 140. The neural network (NN) 130 is a computational approach used in computer science, among other disciplines, and is based on a large collection of neural units, loosely imitating the way a biological brain solves problems with large clusters of biological neurons connected by axons. The neural network 130 is self-learning and trained, rather than programmed, and excels in areas where the solution feature detection is difficult to express in a traditional computer program. During a training phase, the neural network 130 generates a data model 132 based on training inputs, and during a deployment phase, the neural network 130 relies on the data model 132 to generate an output 134. The neural network 130 determines a load torque 134 that is used by the gain estimator to determine the PID gains 144 that are used by the PID controller 110 to determine the actuator correction 118. The autotuning system 120, i.e., the neural network 130 and the gain estimator 124, are configured to predict actuator parameters, such as, but not limited to, friction, inertia, and motor torque using optimization methods online (i.e., during a training phase). As such, the autotuning system 120 does not require prior knowledge of the actuator parameters due to the capability of the PID control system 100 to predict the actuator parameters.

### Training Phase

During the training phase, the neural network 130 uses training data to generate a data model 132 that includes weights and biases which are later used in the deployment phase to predict the system parameters (i.e., to predict the load torque 134). The data model 132 is stored in memory 104. The neural network 130 models the behavior of the actuator 150 based on actuator data 154, such as, but not limited to, speed, current, and voltage (indicative of pulse width modulation (PWM)), and predicts, using the data model 132, the load torque 134 of the actuator 150.

During the training phase the neural network 130 analyzes training data received from one or more training actuators 150 in different conditions and producing different loads, the training data may be collected by running two training actuators back-to-back where one actuator motor acts as a load and the other motor runs different speed points, other methods may also be used to collect the data, for example, electromagnetic brake setup. The collected data may be used as the training data to train the neural network to generate the data model 132. The training actuators may include a bolt on two stage gearset to produce higher torques. Additionally, a torque transducer may be used to identify the load torque in the system. The data may then be used to optimize the neural network 130 using hyper parameter optimization (i.e., size of the hidden layer and number of neurons and delay), and to train the neural network 130. Once the neural network 130 is trained and a data model 132 is generated, the data model 132 is used to determine a load torque 134. Resulting load torque 134 is used as feedforward command to the PID controller 110 and also used by the Gain Estimator algorithm 142 for system parameter estimation.

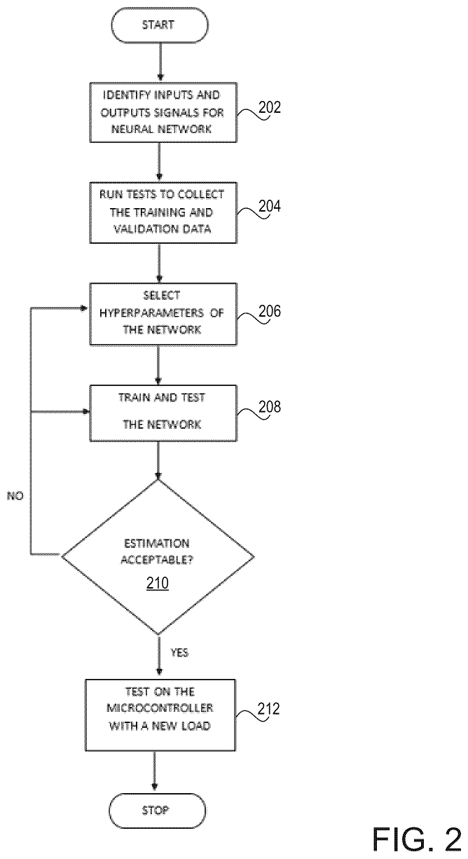

FIG. 2 shows an exemplary flow chart for training the neural network 130. At block 202, manually identify critical parameters of the motor for the Neural Network, where the critical parameters are ones having highest impact. Once the parameters are identified the tests are run to collect the training data. At block 206, during hyperparameter optimization, determine hyperparameters like size of the network. At block 208, the neural network 130 is then trained and tested and if the resulting estimation is acceptable at block 210 the network is tested on an actual microcontroller else the network is trained again.

### Deployment Phase

During the deployment phase, the autotuning system 120 (e.g., the processor 102) receives actuator data 154 from the actuator 150 and determines the load torque 134 of the motor 152 based on the received actuator data 154 and the trained data model 132. The actuator data 154 received from the actuator 150 may include but is not limited to the speed of the motor 21 and the current of the motor 152.

The neural network 130 receives the actuator data 154 and determines the motor load torque 134 based on the data model 132 stored in memory 104. In some examples, the neural network 130 determines the load torque 134 based on the actuator data 154 (e.g., speed and current) and a duty cycle from the current control loop 116 to estimate the load torque 134 which is then used to estimate system parameters

Additionally, the gain estimator 140 determines the PID gains 144 based on the load torque 134 and the actuator data 154.

To calculate the PID gains 144, the gain estimator 140 approximates the motor model to a first order system, then mechanical parameters of the motor 152 such as inertia and coefficient of friction are estimated based on the load torque 134 and the motor data 154 (i.e., speed and current). In some examples, the gain estimator 140 uses the Recursive Least Square (RLSQ) optimization algorithm method to determine the PID gains 144. Other optimization methods may also be used.

The RLSQ algorithm is executed by the processor 102 recursively in real time based on the estimated load torque 134, motor speed and current 154, 154a for the estimation of the parameters by optimizing the following equation:

$$ε = ω - {X}^{T} ϕ \qquad ( 1 )$$

where, ε is the RLSQ algorithm, ω is the actuator output i.e., speed 154a, X is the measurement vector (speed and the current) and parameter set Φ^{T}=[α,β] are function of inertia and coefficient of friction of the actuator 150.

The parameters α and β are a function of the mechanical subsystem friction and inertia, as it maps to a continuous time system as follows:

$${Φ}_{k} = {Φ}_{k - 1} + {K}_{k} ϵ ; \qquad ( 2 )$$

$${K}_{k} = \frac{{P}_{k - 1} {X}_{k}}{λ + {X}_{k}^{T} {P}_{k - 1} {X}_{k}} ; \qquad ( 3 )$$

$${P}_{k} = \frac{1}{λ} ( {P}_{k - 1} - \frac{{P}_{k - 1} {X}_{k} {X}_{k}^{T} {P}_{k - 1}}{λ + {X}_{k}^{T} {P}_{k - 1} {X}_{k}} ) \qquad ( 4 )$$

$$\frac{{ω}_{k} - {ω}_{k - 1}}{{T}_{S}} \approx - {J}_{m}^{- 1} {k}_{f} {ω}_{k - 1} + {J}_{m}^{- 1} {k}_{τ} {i}_{k - 1} \qquad ( 5 )$$

$${ω}_{k} = α {ω}_{k - 1} + β {i}_{k - 1} ; \qquad ( 6 )$$

$$where : α = ( 1 - {J}_{m} {k}_{f} ) {T}_{S} \qquad ( 6 a )$$

$$β = {k}_{τ} {T}_{S} {J}_{m} \qquad ( 6 b )$$

where ωₖ is the motor speed at the current sample, ωₖ₋₁, iₖ₋₁ are the motor speed and motor current at the previous sample and λ is known as “forgetting factor”, Jₘ is the system inertia, k_{f} is linear friction coefficient, k_{τ}i is the torque source, Tₛ is the sampling time. Equation 5 is the motor equation.

In Laplace domain, the continuous time system resembles a low pass filter with time constant τ and steady state gain K:

$$\frac{Ω ( s )}{I ( s )} = \frac{K}{τ s + {1}^{′}} ; \qquad ( 7 )$$

$$K = \frac{β}{1 - {α}^{′}} ; \qquad ( 8 )$$

$$τ = \frac{{T}_{sampling}}{1 - α} . \qquad ( 9 )$$

where T_{sampling} is the time step of the RLSQ algorithm.

Using the estimated time constant and steady state gain, the control loop 112, 114, 116 can be tuned using equations 10, 11, and 12. In this case, the speed request 113, current request 115, and:

$${k}_{p , p} = \frac{4}{{T}_{position}} ; \qquad ( 10 )$$

$${k}_{i , s} = \frac{4 {k}_{f}}{{T}_{speed}} ; \qquad ( 11 )$$

$${k}_{p , s} = \frac{4 {J}_{m}}{{T}_{speed}} . \qquad ( 12 )$$

Where k_{i,s}—integral gain (Speed) (i.e., current gain 115), k_{p,s}—proportional gain (Speed), and T_{speed}—desired settling time.

k_{p,p}—proportional gain for position control for the settling time Tₚₒₛᵢₜᵢₒₙ.

In some examples, to further improve the performance of the PID controller 110, the estimated load torque 134 can be used as a feed-forward command in the current controller 116, which will improve the response of the actuator 150.

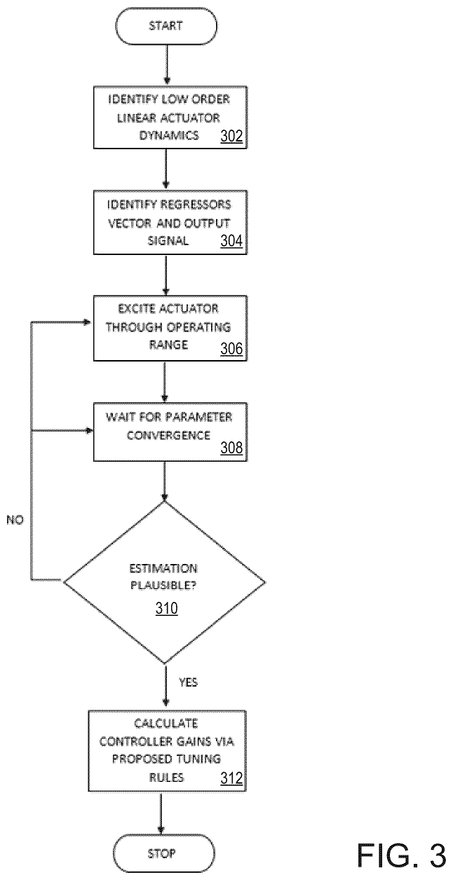

FIG. 3 illustrates the parameter estimation at the gain estimator 140 using the RLSQ method to calculate the PID gains 144. The actuator 200 is first approximated as a low order linear system at block 302. At block 304, the gain estimator 140 identifies the regressors (e.g., inertia and coefficient of friction) by commanding the actuator 150 to travel across an operation range. These parameters are regressed until the error between actual output and estimated output (in our case speed) has minimized. Once the parameters converge and can be accepted, they are used to calculate the gains 144. Else, the optimization is run again.

The disclosure provides ease of implementation in an embedded environment, ease of implementation in a model-based environment, performance in Floating point arithmetic and Impact on the throughput of the microcontroller. Each attribute was assigned a weightage and the concepts were ranked based on the final accumulated score.

The proposed system and method can be easily designed in a model-based environment and executed on a microcontroller with the floating-point unit.

The PID control system 100 provides a method for autotuning the PID controller 110 which is independent of the application the PID controller 110 being used and provides fast, stable, and efficient response which requires minimum manual intervention. Additionally, the PID control system 100 provides minimum impact on the system throughput during development phase so prior to this methodology, fine tuning the PID gains based on the load setup of the actuator 150. Autotuning the PID gains for the actuator 150 is independent of the actuator load or the actuator application. As such, the PID control system 100 could be off the shelf and used for any actuator 150 irrespective of its application.

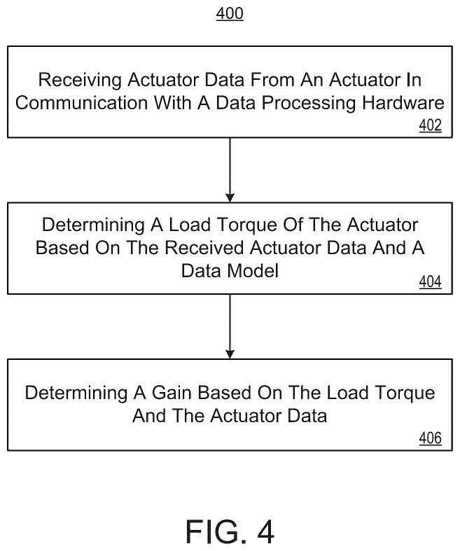

FIG. 4 provides an example arrangement of operations for a method 400 for determining gains of a PID controller 110 using the system of FIGS. 1-3. At block 402, the method includes receiving, at data processing hardware 102, actuator data 154, 154a from an actuator 150 in communication with the data processing hardware 102. The data processing hardware may include a neural network.

At block 404, the method 400 includes determining, at the data processing hardware 102, a load torque 134 of the actuator 150 based on the received actuator data 154, 154a and a data model 132. The actuator data 154, 154a includes speed value and a current value associated with an electric motor 152 of the actuator 150. The data model 132 is stored on memory hardware 104 in communication with the data processing hardware 102. The data model 132 may include neural network weights and biases along with other neural network parameters. In some examples, the load torque 134 is forward fed to a current control 116 of the PID controller 110.

At block 406, the method 400 includes determining, at the data processing hardware 102, a gain 144 based on the load torque 134 and the actuator data 154, 154a.

In some examples, the method 400 also includes receiving a duty cycle 118 from the PID controller 110. The PID controller 110 is in communication with the data processing hardware 102. In this case, the load torque 134 is also determined based on the duty cycle 118.

The data model 132 may be generated based on training actuator data 154, 154a of one or more actuators 150 run at different times under different parameters.

In some implementations, the method 400 further includes transmitting the gain 144 to the PID controller 110, where the PID controller applies a correction to the actuator 150 based on the gain 144.

Various implementations of the systems and techniques described here can be realized in digital electronic circuitry, integrated circuitry, specially designed ASICS (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Implementations of the subject matter and the functional operations described in this specification can be implemented in digital electronic circuitry, or in computer software, firmware, or hardware, including the structures disclosed in this specification and their structural equivalents, or in combinations of one or more of them. Moreover, subject matter described in this specification can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The terms “data processing apparatus”, “computing device” and “computing processor” encompass all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

Similarly, while operations are depicted in the drawings in a particular order, this should not be understood as requiring that such operations be performed in the particular order shown or in sequential order, or that all illustrated operations be performed, to achieve desirable results. In certain circumstances, multi-tasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

A number of implementations have been described. Nevertheless, it will be understood that various modifications may be made without departing from the spirit and scope of the disclosure. Accordingly, other implementations are within the scope of the following claims.

What is claimed is:

1. A method for determining gains of a Proportional-Integral-Derivative (PID) controller, the method comprising:
receiving, at data processing hardware, actuator data from an actuator in communication with the data processing hardware;
determining, at the data processing hardware, a load torque of the actuator based on the received actuator data and a data model, the data model stored on memory hardware in communication with the data processing hardware; and
determining, at the data processing hardware, a gain based on the load torque and the actuator data.

2. The method of claim 1, wherein the load torque is forward fed to a current control of the PID controller.

3. The method of claim 1, further comprising:
receiving a duty cycle from the PID controller, the PID controller in communication with the data processing hardware, wherein the load torque is also determined based on the duty cycle.

4. The method of claim 1, wherein the data model comprises neural network weights and biases along with other neural network parameters.

5. The method of claim 1, wherein the actuator data comprises a speed value and a current value associated with an electric motor of the actuator.

6. The method of claim 1, wherein the data processing hardware comprises a neural network.

7. The method of claim 1, wherein the data model is generated based on training actuator data of one or more actuators run at different times under different parameters.

8. The method of claim 1, further comprising:
transmitting the gain to the PID controller, the PID controller configured to apply a correction to the actuator based on the gain.

9. A system for computing Proportional-Integral-Derivative (PID) gains for improving performance of an electromechanical actuator, the system includes:
data processing hardware; and
memory hardware in communication with the data processing hardware, the memory hardware storing instructions that when executed on the data processing hardware cause the data processing hardware to perform operations comprising:
receiving actuator data from an actuator in communication with the data processing hardware;
determining a load torque of the actuator based on the received actuator data and a data model, the data model stored on the memory hardware; and
determining a gain based on the load torque and the actuator data.

10. The system of claim 9, wherein the load torque is forward fed to a current control of the PID controller.

11. The system of claim 9, wherein the operations further comprise:
receiving a duty cycle from the PID controller, the PID controller in communication with the data processing hardware, wherein the load torque is also determined based on the duty cycle.

12. The system of claim 9, wherein the data model comprises neural network weights and biases along with other neural network parameters.

13. The system of claim 9, wherein the actuator data comprises a speed value and a current value associated with an electric motor of the actuator.

14. The system of claim 9, wherein the data processing hardware comprises a neural network.

15. The system of claim 9, wherein the data model is generated based on training actuator data of one or more actuators run at different times under different parameters.

16. The system of claim 9, wherein the operations further comprise:
transmitting the gain to the PID controller, the PID controller configured to apply a correction to the actuator based on the gain.
